(19) United States
(12) Patent Application Publication
(10) Pub. No.: US 2020/0009640 A1
(43) Pub. Date: Jan. 9, 2020

(54) METHOD FOR PRODUCING A COMPONENT COMPRISING A ROW OF TEETH FOR ADJUSTING A MOTOR VEHICLE SEAT

(71) Applicant: Faurecia Autositze GmbH, Stadthagen (DE)

(72) Inventors: Hosen Sulaiman, Dortmund (DE); Heinz-Werner Dettmer, Nordsehl (DE); Markus Schenke, Petershagen (DE); Jens Witt, Nienstadt (DE)

(21) Appl. No.: 16/502,875

(22) Filed: Jul. 3, 2019

(30) Foreign Application Priority Data
Jul. 6, 2018 (DE) 102018116412.2

(51) Int. Cl. B21D 53/88; B21D 22/02; B21D 35/00

(52) U.S. Cl. CPC B21D 53/88; B60N 2/1875; B21D 35/001; B21D 22/022

(57) ABSTRACT

A method for producing a component comprising a row of teeth for adjusting a motor vehicle seat. A method of producing the component includes the row of teeth being pre-cut to its raw contours and subsequently heated and, in this state, shaped into its final contours in a stamping tool, or in that the region of the component in which the row of teeth is to be formed is heated and subsequently, in this state, cut to its final shape in punching tool.

### PRIORITY CLAIM

This application claims priority to German Application No. 10 2018 116 412.2, filed Jul. 6, 2018, which application is hereby incorporated in its entirety herein.

### BACKGROUND

The present disclosure relates to a method for producing a component comprising a row of teeth for adjusting a motor vehicle seat.

### SUMMARY

According to the present disclosure, a method for producing a component comprising a row of teeth for adjusting a motor vehicle seat. In illustrative embodiments, a method of producing the component includes the row of teeth being pre-cut to its raw contours and subsequently heated and, in this state, shaped into its final contours in a stamping tool, or in that the region of the component in which the row of teeth is to be formed is heated and subsequently, in this state, cut to its final shape in punching tool.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a strip layout for a progressive tool in a top view;

FIG. 2 is a schematic representation of a tool for carrying out a first variation of the method; and

FIG. 3 is a schematic representation of a tool for carrying out a second variation of the production process.

### DETAILED DESCRIPTION

Using a method according to the present disclosure a component 1 is produced which serves for the height adjustment of a motor vehicle seat. It comprises a row of teeth 2 with which, in the assembled state (not shown), a pinion meshes the drive of which causes an adjustment motion of the component 1 to happen.

Subsequently, two variants of the method are described. In both variants of the method, a band 3 is drawn off a coil (not shown) and forwarded to the individual procedure steps.

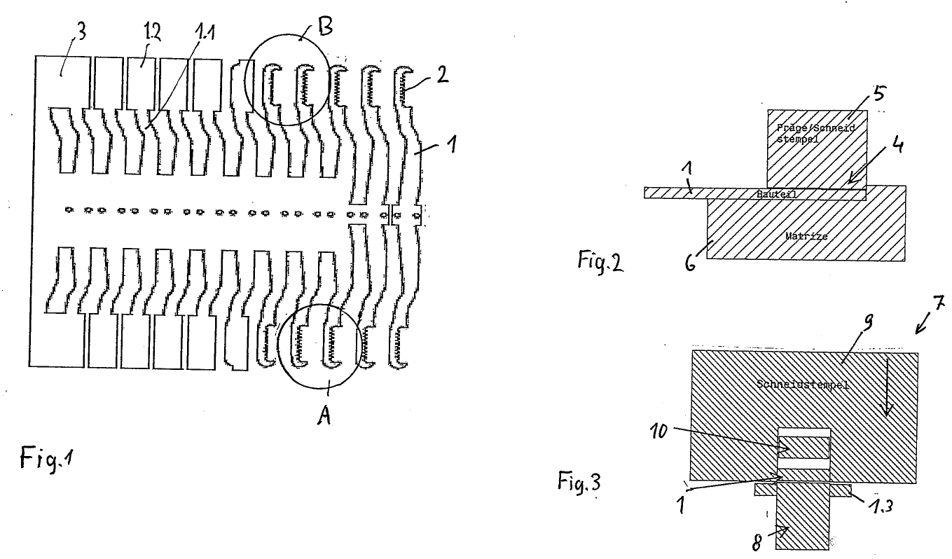

With the first variant of the method, the component 1 is cut step by step and formed in a composite process. Prior to the row of teeth 2 being formed, it has a shape approximately resembling a spoon with a dipper arm region 1.1 and an integrally connected wider functional region 1.2. In the functional region 1.2, the raw contours of the row of teeth 2 are formed by means of cutting and forming, with this contour, however, still exhibiting a certain degree of undersize or, respectively, size allowance. Then, this region is heated inductively in the tool 4 shown in FIG. 2 and stamped between an embossing die 5 and a size plate 6 to attain the finished contours of the row of teeth 2. Hereby, material will flow into the skips so that the die roll in this regions is reduced to a minimum. In this step, which is designated A in the strip layout according to FIG. 1, there also happens, at the same time, the cooling off of the hot component 1 to a certain temperature for structural transformation. The subsequent procedure steps are provided for the further cooling down of the component 1 before this is formed, in a final calibrating step, to the final geometry and cut off the band 3 to create the finished part.

With the second variant of the method, too, the component 1 is cut step by step and formed in a composite process. In this case, however, no raw shape of the row of teeth 2 is produced, but the functional region 1.2 of the component 1 is heated inductively. Then, in the next procedure step, the row of teeth 2 is cut to its final dimensions. In this step, which is designated B in the strip layout according to FIG. 1, there also happens, at the same time, the cooling off of the hot component. FIG. 3 shows schematically the tool 7 for carrying out these procedure steps. The heated functional region 1.2 of the component 1 is clamped in between a bottom 8 of the tool and a cutting stamp 9. The cutting stamp 9 is then pressed downwards against the bottom 8 of the tool thereby cutting the final contours of the row of teeth 2. In the cutting stamp 9 an ejector 10 is axially movable mounted which pushes out the component 1 cut to its final shape from the cutting stamp 9. In this process stamping scrap 1.3 is generated on the bottom 8 of the tool which has to be removed.

The subsequent procedure steps are provided in a manner identical with the first variant of the method for the continued cooling down of the component 1.

Components of this type are high-precision component manufactured by fine-edge blanking and subsequent curing by means of heat treatment. The disadvantages of one comparative manufacturing process are, inter alia, that the forming process generates a high internal stress in the finished part leading to an uncontrollable deviation in dimensions of the component after the heat treatment. Moreover, the two very much separated manufacturing processes—fine-edge blanking and heat treatment—require an increased logistics effort causing high overall cost of manufacturing. A further disadvantage is the die roll created with this manufacturing process leading to a loss of bearing capacity. A method in accordance with the present disclosure overcomes the disadvantages of the comparative manufacturing process.

By virtue of the method according to the present disclosure, it is possible to minimize the afore-mentioned disadvantages. In particular, by means of the cutting and direct forming (embossing) of the row of teeth, the die roll in this region can be reduced to a minimum due to the flow of material. A further advantage is that the deviations from the dimensions of the component can be reduced. Moreover, by means of the method according to the present disclosure it is possible to cover a wider spectrum of components that with fine blanking because fine blanking is limited by the dimensions of the automatic punching press.

One embodiment of the present disclosure is that the component is completed in a composite process from a coil, i.e., the component is completed in situ.

This minimizes the logistics efforts required in the state of the art leading to a reduction in cost.

The present disclosure relates to a method for producing a component comprising a row of teeth for adjusting a motor vehicle seat. A method in accordance with the present disclosure overcomes issues with comparative manufacturing processes. This task is solved in that the row of teeth 2 is pre-cut to its raw contours and subsequently heated and, in this state, shaped into its final contours in a stamping tool 4, or in that the region 1.2 of the component 1 in which the row of teeth 2 is to be formed is heated and subsequently, in this state, cut to its final shape in punching tool 7.

1. A method for producing a component comprising a row of teeth for adjusting a motor vehicle seat,
wherein the row of teeth is pre-cut to its raw contours and subsequently heated and, in this state, shaped into its final contours in a stamping tool, or
wherein the region of the component in which the row of teeth is to be formed is heated and subsequently, in this state, cut to its final shape in a punching tool.

2. The method of claim 1, wherein the component is completed in a composite process from a coil.

3. The method of claim 2, wherein the heating is created by induction.

4. The method of claim 3, wherein the component, after final contours of the row of teeth have been formed, is cooled off in several steps.
